(19) United States
(12) Patent Application Publication
(10) Pub. No.: US 2007/0127659 A1
(43) Pub. Date: Jun. 7, 2007

(54) Remote telecommunication privacy device

(76) Inventors: Daniel James McClory, Middleton, MA (US); Edward Michael Salem, Peabody, MA (US)

Correspondence Address: Daniel J McClory, 20 River Street, Middleton, MA, 01949, US

(21) Appl. No.: 11/594,285

(22) Filed: Nov. 9, 2006

Related U.S. Application Data
(60) Provisional application No. 60/737,515, filed on Nov. 17, 2005.

(51) Int. Cl. H04M 1/00

(52) U.S. Cl. 379/161

(57) ABSTRACT

A sound-muffling remote accessory for communication devices. The accessory comprises a remote mouthpiece and earpiece that is wired to, or transmits wirelessly to, a telephone or two-way radio. The mouthpiece generally conforms to the shape of the user's face and is designed in such a way that when spoken into, little or no sound escapes to the immediate vicinity.

### RELATED APPLICATIONS

The present application is a continuation-in-part application of U.S. provisional patent application Ser. No. 60/737,515, filed Nov. 17, 2005, for TELECOMMUNICATION PRIVACY DEVICE, by Daniel J McClory, included by reference herein and for which benefit of the priority date is hereby claimed.

### FIELD OF THE INVENTION

The present invention relates to accessories for telecommunication devices and, more particularly, to accessories that provide the user with enhanced privacy and acoustic performance.

### BACKGROUND OF THE INVENTION

Telephones have been commonly used for many years. Telephones used in public places and other congested areas such as office cubicles have a significant drawback regarding privacy; Conversation can be heard by people in the immediate vicinity. It is not always desirable for a person to reveal the contents of his or her conversations to everyone near them. Conversely, many people in a public environment feel disturbed when a person nearby is carrying on a loud yet private conversation on a telephone.

The advent of mobile phones has greatly magnified this problem. The use of cellular phones is becoming ubiquitous in public locations such as restaurants, theatres, sporting events and the like. Because of frequent poor reception it is common for a person to talk at a higher than normal volume while on a cell phone. Another contributing problem is the design of cell phones. In recent times the size of these devices has shrunk to the point where a person's mouth, while using a cell phone, is not always in close proximity to the microphone portion of the cell phone. This causes the user to speak louder than normal during conversations. The nature of many phone calls is private in and not meant to be broadcast to all surrounding people. Many cell phone users feel uncomfortable or embarrassed when speaking in a public environment.

In addition to lack of privacy, certain environments can cause poor acoustic performance for telephone users. Because of the design of most conventional and mobile phones, a lot of unwanted background noise can be transmitted through the device's microphone during conversations. Windy days, loud factories, concerts, etc can make it difficult or impossible to converse through a telephone.

Many attempts at increasing the privacy of telephone users exist in the prior art. An early example of this was U.S. Pat. No. 271,903, which describes a “mouthpiece for telephone transmitters” by A. S. Nichols that afforded the user oral privacy by speaking into an attached mouthpiece housing during telephone conversations. Other iterations of this concept were later patented including; U.S. Pat. Nos. 1,399,083, 1,529,537, 2,020,970, 2,131,820, 2,245,724, and 2,540,873.

Another avenue taken by those attempting to supply telephone users with increased privacy is the development of what is commonly known as “white noise” generators. These are devices usually intended for office use that produce a background noise making it difficult for people in the immediate vicinity of the telephone conversation to perceive what is being talked about. An example of this includes U.S. Pat. No. 4,010,324, a “background noisemaking system” by Jarvis, et al. which describes a system to be used in an office environment that generates a privacy-increasing noise. Another example of a white noise generator is U.S. Pat. No. 4,052,564 “masking sound generator” by Probst, et al. which portrays a smaller and easy to install sound generator.

Noise cancellation technology has also been employed to increase telephone users' privacy. Many examples of this exist in the prior art including U.S. Pat. No. 6,690,800, “Method and apparatus for communication operator privacy” by Resnick, which depicts a noise canceling technology that when integrated with a telephone's mouthpiece uses active acoustic cancellation to silence the voice of the operator and reduce the amount of spoken sound that would normally emit to the surrounding area. Other examples of this type of privacy solution are expressed in U.S. Pat. Nos. 6,754,353 and 7,088,828.

The prior art regarding privacy solutions for telephone users have some drawbacks. Mufflers that attach to a mouthpiece can be cumbersome and may interfere with the normal operation of the device. Additionally, the vast number of phone handpiece configurations would make the effective design of such a device for conventional and mobile models extremely difficult.

White noise generators can afford the user with increased speaking privacy but at the price of greater background noise. Rather than inhibit sound from emitting to the surrounding area, their method of operation requires additional noise to “drown out” telephone conversational sound. Also, because they are not portable, noise generators are limited to home or office use.

Noise cancellation technology requires extensive redesign of the telephone's microphone circuitry and would likely add a considerable production expense. The technology is also immature and may not sufficiently cancel all spoken sound.

It is therefore an object of the invention to provide a better way to speak privately on a telecommunication device while in a populated location.

It is another object of the invention to provide a device that helps to reduce or eliminate the annoying chatter that bystanders to telephone users are subjected to.

It is another object of the invention to provide a shield that helps to reduce unwanted background noise from the surrounding area being transmitted through the microphone of a telecommunication device during conversations.

It is another object of the invention to allow users to speak more softly than would normally be required when using a conventional phone, mobile phone, or two-way radio.

It is another object of the invention to provide an accessory that can be easily added to and removed from a conventional phone, mobile phone, or two-way radio.

It is another object of the invention to provide a privacy shield that prohibits people in the vicinity from seeing the mouth movement of the user.

Other objects and advantages of the present invention will become apparent from the following descriptions, taken in connection with the accompanying drawings, wherein, by way of illustration and example, possible embodiments of the present invention are disclosed.

### SUMMARY OF THE INVENTION

In accordance with the present invention, there is provided a remote sound-muffling accessory for communication devices. The accessory comprises a mouthpiece and earpiece that is wired to, or transmits wirelessly to, a remote telephone or two-way radio. The mouthpiece generally conforms to the shape of the user's face and is designed in such a way that when spoken into, little or no sound escapes to the immediate vicinity.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an inner perspective view of a possible embodiment of the remote telecommunication privacy device in accordance with the invention;

FIG. 2 is a perspective view of a person using a possible embodiment of the remote telecommunication privacy device in accordance with the current invention;

FIG. 3 is a perspective view of a person speaking into a conventional mobile phone;

FIG. 4 is a perspective view of a desktop embodiment of the invention that is wired to a dedicated telephone;

FIG. 5 is a perspective view of a mouthpiece—only embodiment of the present invention that is shown closed, open, and in use by a person who is using a mobile phone for an earpiece;

FIG. 6 is a perspective view of a person using an embodiment of the current invention that has a wireless earpiece and a wireless mouthpiece;

FIG. 7 is a block diagram view of an embodiment of the present invention that is wirelessly coupled to a dedicated telephone and has a wirelessly coupled earpiece;

FIG. 8 is a block diagram view of an embodiment of the present invention that is wirelessly coupled to a dedicated telephone and has an integrated hard-wired earpiece;

FIG. 9 is a block diagram view of an embodiment of the present invention that is wired to a dedicated telephone and has an integrated hard-wired earpiece; and

FIG. 10 is a block diagram view of a mouthpiece—only embodiment of the present invention that is wirelessly coupled to a dedicated telephone.

For purposes of clarity and brevity, like elements and components will bear the same designations and numbering throughout the Figures.

### DESCRIPTION OF THE PREFERRED EMBODIMENT

In operation, the present invention attenuates spoken noise by mechanically blocking sound. When used in populated locations, this increases the privacy for users of telephones, mobile phones and two-way radios.

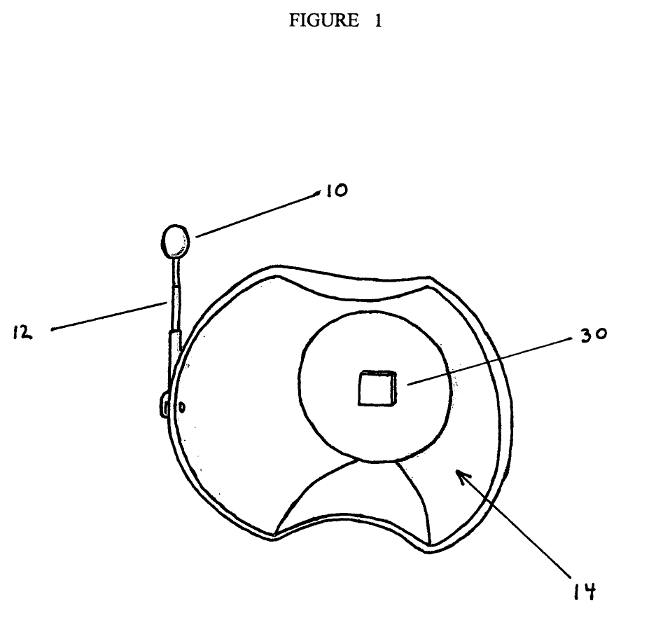

The general function of the invention is illustrated in FIG. 1 and summarized as follows. A microphone 30 or acoustic sensor housed within a speaking cavity 14 captures the operator's speech, which it immediately transmits to a dedicated telecommunication device. An earpiece 10 containing a speaker delivers an acoustic signal from the dedicated telecommunication device to the operator's ear. A positioning arm 12 allows the operator to locate the earpiece 10 adjacent to their ear.

As shown in FIG. 1 the main facilitator to dampening sound and increasing user privacy is the mouthpiece 50 and its concave-shaped speaking cavity 14. This feature is contoured to fit under the nose and around the user's mouth 42. The mouthpiece 50 could be fabricated from plastics, metals, composites, or any other suitable material. Multiple layers with either an air space or insulating material between each layer would improve the acoustic dampening effect of the speaking cavity 14.

Another essential purpose of the mouthpiece 50 is to house the communication related circuitry, which in the preferred embodiment includes a microphone 30, speaker, power-supply battery, and means to communicate to a dedicated telephone, mobile phone 24 or two-way radio.

The microphone 30 housed within the mouthpiece's speaking cavity 14 is positioned to be directly in front of the operator's mouth while speaking. This is the optimum position for acoustic transmission of spoken sound to the microphone 30 and allows the operator to speak at a low volume. Microphones of this type are common in the art especially regarding headsets to be used with mobile or conventional phones. Once spoken sound is picked up by the microphone 30 it is immediately transmitted to the dedicated telephone, mobile phone 24, or two-way radio either through a wire or by utilizing short-range wireless technology such as “Bluetooth”. A good example of this is offered by Plantronics in their “MX250 Mobile Headset” which includes a microphone and earpiece wired to a mobile phone. Another example is the “Explorer 320 Bluetooth Headset” by Plantronics, which wirelessly communicates with a mobile phone. The main benefit supplied by the Plantronics devices and virtually all other commercially available remote headsets it that they allow users to operate telephones while leaving their hands free. Using such headsets in no way increases privacy for the user.

The earpiece 10 of the present invention delivers acoustic signals from the dedicated telephone, mobile phone 24, or two-way radio to the operator's ear. The earpiece 10 can be adjustably attached to the speaking cavity 14 or wirelessly coupled by again using short-range wireless technology such as “Bluetooth”. The speaker within the earpiece 10 would include a volume control in the preferred embodiment, and in the wireless version also contains a separate power-supply battery. Examples of similar earpieces and the means to power earpiece 10 and mouthpiece 50 headsets can be seen in many commercially available headsets such as the Plantronics models referenced earlier.

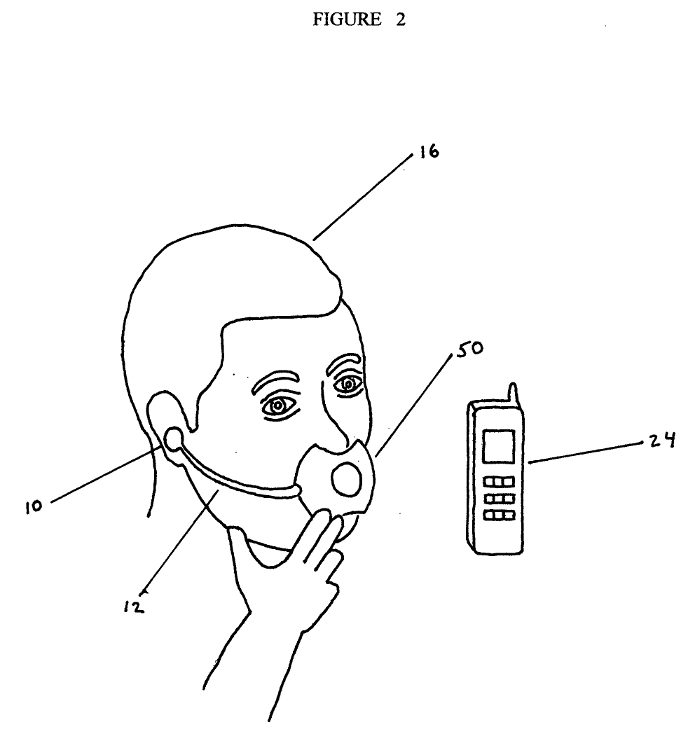

Referring now to FIG. 2, a person 16 is shown privately conversing on a mobile phone 24 using the remote telecommunication privacy device 18. A wireless link is established that allows instant data transmissions between the devices. The unit's mouthpiece 50 is positioned to muffle conversational sound and gives the operator increased privacy during mobile phone 24 conversations. The earpiece 10 has been extended and positioned so that the operator can hear voice signals from the mobile phone 24. The person's mobile phone 24 does not need to be held and can be kept in a pocket or other nearby place. The lip movements of the user cannot be seen and any background noise that may be in the area of the user is not transmitted through the privacy device's mouthpiece 50.

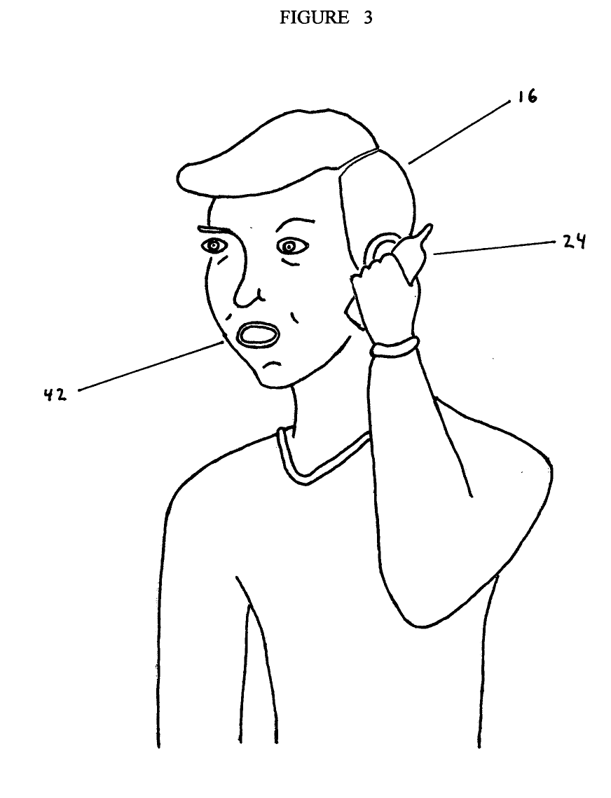

FIG. 3 shows a person 16 using a mobile telephone. Clearly illustrated is the fact that the operator's mouth 42 is not in close proximity to the microphone 30 portion of the mobile telephone. Conversational sound can be heard by people in the immediate vicinity to the person 16 and his lip movements can be seen. Additionally, any loud background noise near the person 16 would be transmitted through the mobile telephone's mouthpiece 50 making conversation difficult. A person 16 using a mobile phone 24 in a populated location may be embarrassed to have the contents of his conversation heard by bystanders. Conversely, people in the immediate vicinity may become annoyed at being forced to hear conversational noise.

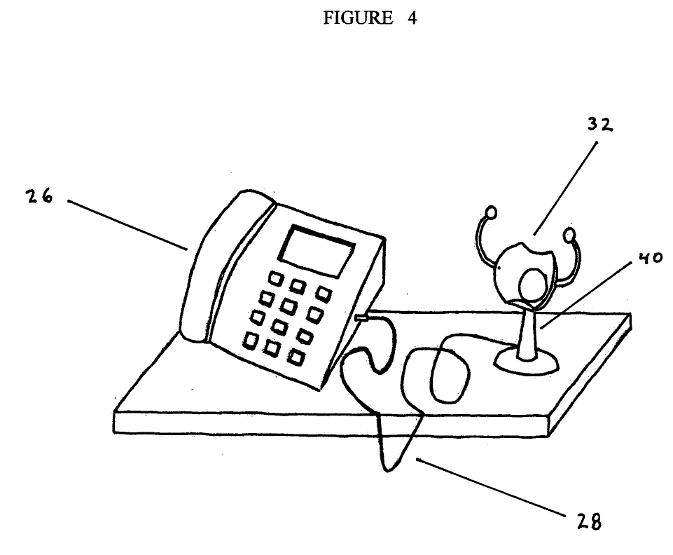

In FIG. 4, a desktop embodiment of the invention is shown that is wired to a dedicated conventional desktop telephone 26. A cable 28 connects the desktop remote telecommunication privacy device 32 to the desktop telephone 26 through its headphone jack and provides a path for data to transfer back and forth between the two units. A base 40 keeps the desktop embodiment of the current invention upright and provides a handle to be used by the operator. This embodiment would increase the privacy of telephone users in home or office settings. A button on the handle or a pressure sensitive switch that activates when the unit is lifted would enable the device.

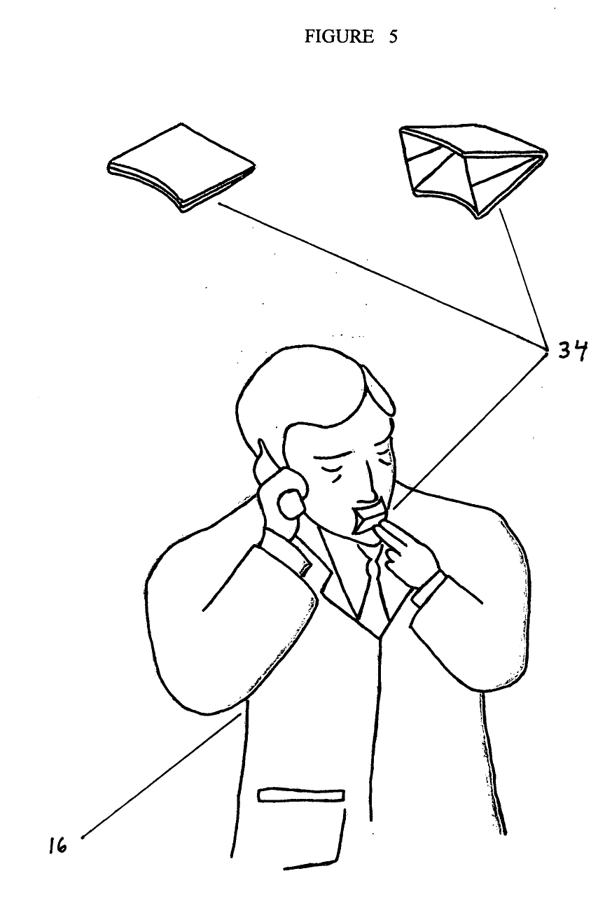

FIG. 5 illustrates a collapsible remote mouthpiece 34 embodiment of the current invention that does not include an earpiece 10. This possible embodiment would be easy to store and transport. Shown closed, open, and in use by a person 16, this embodiment of the invention is intended to increase the operator's privacy by muffling spoken sound when used in conjunction with a mobile phone 24 that serves as the earpiece 10. This embodiment is also ideal for integration with a wristband that would provide the user with an instantly accessible privacy mouthpiece 50.

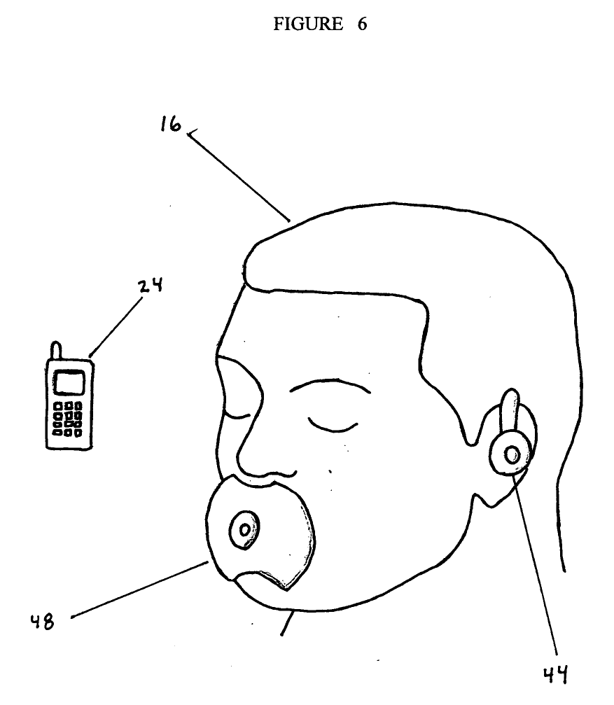

A full wireless remote telecommunication privacy device 18 is shown in FIG. 6. Illustrated is a person 16 using a wireless earpiece 44 and wireless mouthpiece 48 that is remotely communicating with a mobile phone 24. This possible embodiment of the current invention provides the operator with increased privacy when speaking on a mobile phone 24 in a public area and does not require the operator to position an earpiece 10 prior to conversing.

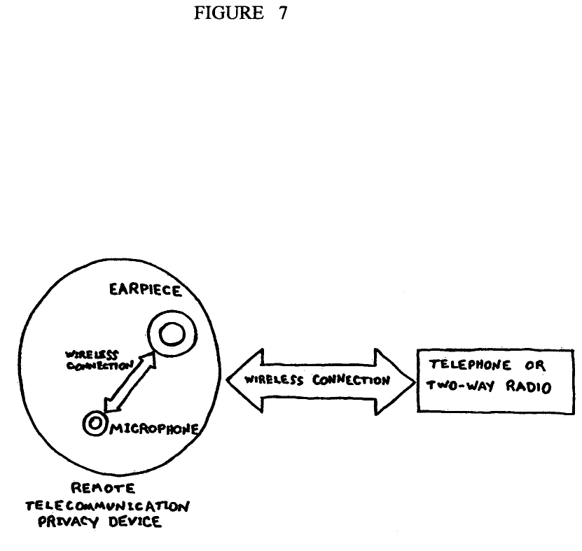

FIG. 7 shows a block diagram of a full wireless embodiment of the present invention such as the version shown in FIG. 6. An earpiece 10 is wirelessly linked to a mouthpiece 50, both of which are wirelessly linked to a telephone or mobile phone 24.

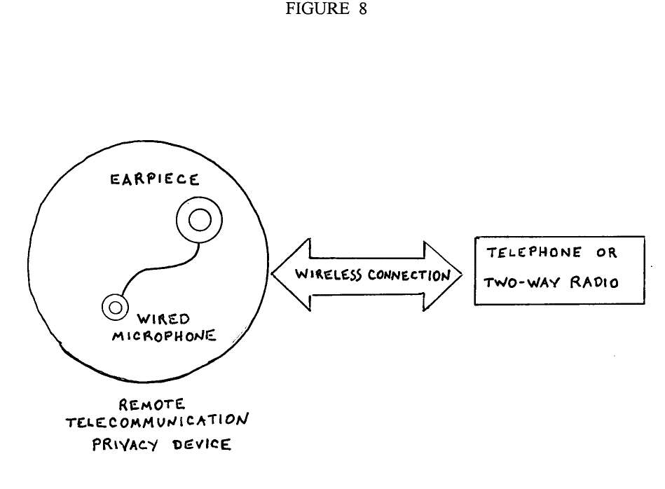

FIG. 8 shows a block diagram of an embodiment of the present invention in which the mouthpiece 50 and hard-wired earpiece 10 are wirelessly linked to a telephone or mobile phone 24. A possible embodiment of this configuration is also shown in FIGS. 1 and 2.

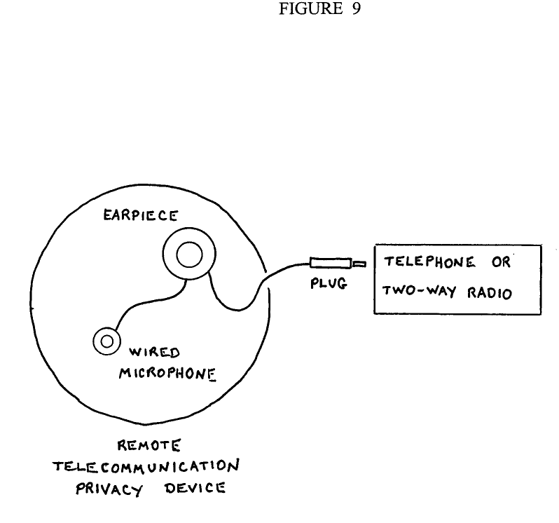

FIG. 9 shows a block diagram of an embodiment of the present invention in which the mouthpiece 50 and earpiece 10 are wired together, both of which are linked through a wire to a telephone or mobile phone 24. An embodiment of this configuration is also show in FIG. 4.

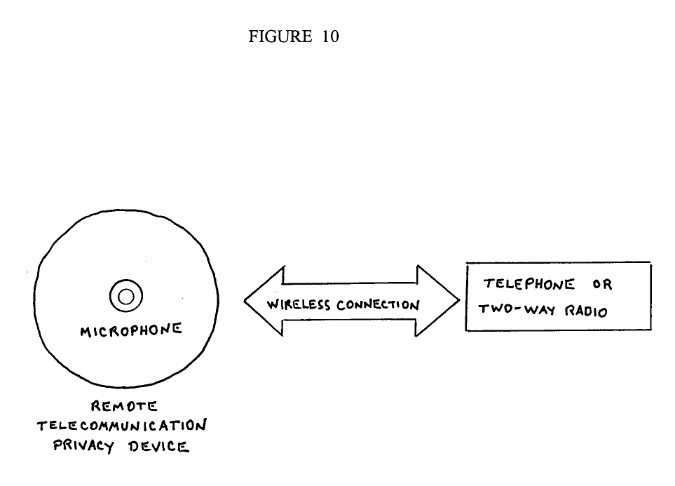

FIG. 10 shows a block diagram of an embodiment of the present invention that consists of a mouthpiece 50 that is wirelessly linked to a telephone or mobile phone 24. An embodiment of this mouthpiece 50—only version of the present invention is shown in FIG. 5.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A remote telecommunication privacy device for conventional telephones, mobile telephones and two-way radios, comprising:
means for allowing the user to hear incoming communications;
means for allowing the user to properly position the earpiece during use and to collapse the earpiece for easier portability when not in use, adjustably connected to said means for allowing the user to hear incoming communications;
means for attenuating the amount of spoken sound that emits to the surrounding area during conversations while fitting snugly over the user's face;
means for transmission of spoken sound to the dedicated telephone, mobile phone, or 2-way radio, rigidly connected to said means for attenuating the amount of spoken sound that emits to the surrounding area during conversations while fitting snugly over the user's face;
means for providing increased privacy for the user while allowing full-functionality regarding remotely transmitting signals to, and receiving signals from, a communication device;
means for connecting the telecommunication privacy device to its dedicated telephone and providing a path for the transmissions to travel between the devices;
means for remotely communicating with a telephone while increasing a user's privacy in a home or office setting;
means for providing an embodiment of the current invention that is collapsible for easy storage;
means for providing the remote telecommunication privacy device with a stand to keep it in an upright position;
means for providing a wireless earpiece for the remote telecommunication privacy device;
means for housing the microphone and providing the operator with a privacy-increasing speaking pocket while maintaining a wireless link to a remote earpiece and communication device, operationally housed to said means for attenuating the amount of spoken sound that emits to the surrounding area during conversations while fitting snugly over the user's face, and telescopically attached to said means for allowing the user to properly position the earpiece during use and to collapse the earpiece for easier portability when not in use; and
means for containing all of the major elements of the remote telecommunication privacy device.

2. The remote telecommunication privacy device in accordance with claim 1, wherein said means for allowing the user to hear incoming communications comprises an earpiece.

3. The remote telecommunication privacy device in accordance with claim 1, wherein said means for allowing the user to properly position the earpiece during use and to collapse the earpiece for easier portability when not in use comprises a telescoping, pivoting positioning arm.

4. The remote telecommunication privacy device in accordance with claim 1, wherein said means for attenuating the amount of spoken sound that emits to the surrounding area during conversations while fitting snugly over the user's face comprises a sound-muffling cavity, contoured to fit user's face speaking cavity.

5. The remote telecommunication privacy device in accordance with claim 1, wherein said means for transmission of spoken sound to the dedicated telephone, mobile phone or 2-way radio comprises a microphone.

6. The remote telecommunication privacy device in accordance with claim 1, wherein said means for providing increased privacy for the user while allowing full-functionality regarding remotely transmitting signals to, and receiving signals from, a communication device comprises a fits over user's mouth, communicates to a remote device, houses microphone, houses speaker, contains electrical circuitry, contains a power supply, contains an earpiece telecommunication privacy device.

7. The remote telecommunication privacy device in accordance with claim 1, wherein said means for connecting the telecommunication privacy device to its dedicated telephone and providing a path for the transmissions to travel between the devices comprises an attaches to telecommunication privacy device, attaches to telephone's headset jack, flexible, sufficient length to permit easy operation cable.

8. The remote telecommunication privacy device in accordance with claim 1, wherein said means for remotely communicating with a telephone while increasing a user's privacy in a home or office setting comprises an attached base, attached handle, sound attenuating cavity, attached earpieces desktop remote telecommunication privacy device.

9. The remote telecommunication privacy device in accordance with claim 1, wherein said means for providing an embodiment of the current invention that is collapsible for easy storage comprises a foldable for easy storage, opens to provide speaking cavity, remotely linked to a communication device, housing for microphone collapsible remote mouthpiece.

10. The remote telecommunication privacy device in accordance with claim 1, wherein said means for providing the remote telecommunication privacy device with a stand to keep it in an upright position comprises a holds privacy device in an upright position, weighted to prevent tip over, attached to privacy device base.

11. The remote telecommunication privacy device in accordance with claim 1, wherein said means for providing a wireless earpiece for the remote telecommunication privacy device comprises a wirelessly coupled earpiece wireless earpiece.

12. The remote telecommunication privacy device in accordance with claim 1, wherein said means for housing the microphone and providing the operator with a privacy-increasing speaking pocket while maintaining a wireless link to a remote earpiece and communication device comprises a wirelessly coupled to earpiece, wirelessly coupled to phone wireless mouthpiece.

13. The remote telecommunication privacy device in accordance with claim 1, wherein said means for containing all of the major elements of the remote telecommunication privacy device comprises a housing for speaking cavity, housing for microphone, housing for earpiece, housing for communications circuitry, housing for battery mouthpiece.

14. A remote telecommunication privacy device for a remote telecommunication privacy device for conventional telephones, mobile telephones and two-way radios, comprising:
an earpiece, for allowing the user to hear incoming communications;
a telescoping, pivoting positioning arm, for allowing the user to properly position the earpiece during use and to collapse the earpiece for easier portability when not in use, adjustably connected to said earpiece;
a sound-muffling cavity, contoured to fit user's face speaking cavity, for attenuating the amount of spoken sound that emits to the surrounding area during conversations while fitting snugly over the user's face;
a microphone, for transmission of spoken sound to the dedicated telephone, mobile phone, or 2-way radio, rigidly connected to said speaking cavity;
a fits over user's mouth, communicates to a remote device, houses microphone, houses speaker, contains electrical circuitry, contains a power supply, contains an earpiece telecommunication privacy device, for providing increased privacy for the user while allowing full-functionality regarding remotely transmitting signals to, and receiving signals from, a communication device;
an attaches to telecommunication privacy device, attaches to telephones headset jack, flexible, sufficient length to permit easy operation cable, for connecting the telecommunication privacy device to its dedicated telephone and providing a path for the transmissions to travel between the devices;
an attached base, attached handle, sound attenuating cavity, attached earpieces desktop remote telecommunication privacy device, for remotely communicating with a telephone while increasing a user's privacy in a home or office setting;
a foldable for easy storage, opens to provide speaking cavity, remotely linked to a communication device, housing for microphone collapsible remote mouthpiece, for providing an embodiment of the current invention that is collapsible for easy storage;
a holds privacy device in an upright position, weighted to prevent tip over, attached to privacy device base, for providing the remote telecommunication privacy device with a stand to keep it in an upright position;
a wirelessly coupled earpiece wireless earpiece, for providing a wireless earpiece for the remote telecommunication privacy device;
a wirelessly coupled to earpiece, wirelessly coupled to phone wireless mouthpiece, for housing the microphone and providing the operator with a privacy-increasing speaking pocket while maintaining a wireless link to a remote earpiece and communication device, operationally housed to said speaking cavity, and telescopically attached to said positioning arm; and
a housing for speaking cavity, housing for microphone, housing for earpiece, housing for communications circuitry, housing for battery mouthpiece, for containing all of the major elements of the remote telecommunication privacy device.
